(19) United States
(12) Patent Application Publication
(10) Pub. No.: US 2013/0095210 A1
(43) Pub. Date: Apr. 18, 2013

(54) Complex Coacervates and Aqueous Dispersions of Complex Coacervates and Methods of Making Same

(71) Applicants: Naijie Zhang, Ridgefield, CT (US); William Mutilangi, Peekskill, NY (US)

(72) Inventors: Naijie Zhang, Ridgefield, CT (US); William Mutilangi, Peekskill, NY (US)

(73) Assignee: PepsiCo, Inc., Purchase, NY (US)

(21) Appl. No.: 13/272,270

(22) Filed: Oct. 13, 2011

(51) Int. Cl. A23L 2/00; A23L 1/302; A23L 1/304; A23L 1/0522; A23L 1/0526; A23L 1/0524; A23L 1/053; A23L 1/0532; A23L 1/0534; A23L 1/054; A23L 1/056; A23L 1/0562; A23D 9/00; A23L 1/22; A23L 1/00; A23L 3/00; A23L 1/03; A23L 1/28; A23L 1/223; A23J 7/00; A23J 1/20; A23L 1/305; A23J 1/14; A23J 1/08; A23J 1/12; A23J 1/00; A23L 1/48

(52) U.S. Cl. 426/72; 426/89; 426/74; 426/103; 426/531; 426/541; 426/654

(57) ABSTRACT

Edible complex coacervates and aqueous dispersions of complex coacervates are disclosed, that may be utilized to protect a sensitive substance, e.g., fish oil or omega-3 fatty acids or other hydrophobic substances or sensitive hydrophilic substances. The complex coacervates and aqueous dispersions may be utilized in food products. Methods for producing the complex coacervates and aqueous dispersions are also disclosed.

### TECHNICAL FIELD OF THE INVENTION

The present invention relates to the field of protecting a hydrophobic substance from hydrolysis and oxidation, more particularly complex coacervates containing sensitive substances in an aqueous dispersion such as food products.

### BACKGROUND OF THE INVENTION

Certain sensitive substances are desirable as ingredients in food products, such as in, for example, beverages. Such sensitive substances may be hydrophobic substances or hydrophilic substances. In some cases such a hydrophobic substance does not have an acceptable taste or taste profile or is not sufficiently stable in an acidic environment. Examples of such hydrophobic substances include omega-3 fatty acids, water-insoluble flavorants, water-insoluble vitamins, etc. Certain hydrophobic substances have been discovered to have beneficial health effects. For example, omega-3 and omega-6 fatty acids form an important part of the human diet. Eicosapentaenoic acid (EPA) and docosahexaenoic acid (DHA), long-chain forms of omega-3 fatty acids, are understood in many cases to support brain and cardiovascular health and functions, amongst other health benefits. It has been suggested that consumption of omega-3 fatty acids should be increased.

Previously, sensitive substances were incorporated directly into an aqueous system as a solution (with a compatible solvent), an extract, an emulsion, or a micellular dispersion (a so-called microemulsion). While all of these approaches serve to disperse the sensitive substance in an aqueous system, they do not provide extended protection against hydrolysis and oxidation. Commercially available fish oils can be high in omega-3 fatty acids, and in some cases are “encapsulated,” but these commercially available fish oils have not proven adequately stable in all food contexts, e.g., physically or taste-stable in acidic food products. This can result in negative changes to the food product, such as unpleasant fishy flavors and aromas after ingestion, particularly a fishy aftertaste caused by belching fish oil from the stomach. Additionally, omega-3 fatty acids, as well as many water-insoluble flavorants, water-insoluble vitamins, etc. are unstable to degradation, e.g., by oxidation or hydrolysis, when exposed to air, water and/or light.

It would be desirable to provide edible compositions suitable for use in food products, which compositions incorporate one or more sensitive substances in a stable form, e.g., sensitive hydrophobic substances in a form that is shelf stable in an aqueous beverage, syrup, etc. It also would be desirable to provide food products incorporating such edible compositions. At least certain of the embodiments of the new compositions disclosed below can reduce or eliminate the unpleasant taste and odor of the one or more incorporated sensitive substances when used as an ingredient in a food product suitable for consumption by a human or animal. At least certain of the embodiments of the new compositions disclosed below provide sensitive substances in a stable form for use in aqueous systems such as beverages or other food products. In at least some embodiments the sensitive substance is stable to oxidation and hydrolysis during the shelf life of the food product. In at least some embodiments the sensitive substance is stable to oxidation and hydrolysis in an acidic food product, e.g. a food product at pH less than pH 5.0 and in some cases less than pH 3.5. Additional features and advantages of some or all of the food products disclosed here will be apparent to those who are skilled in food technology given the benefit of the following summary and description of exemplary, non-limiting examples.

### SUMMARY

Aspects of the invention are directed to delivery systems for sensitive substances, for example hydrophobic substances, e.g., fish oil, and/or hydrophilic substances, substances prone to oxidation or other degradation when included as an ingredient in a food product, e.g., in a beverage or a beverage concentrate (the latter being alternatively referred to here as a syrup). The delivery systems disclosed here protect or preserve the sensitive substance and in some cases can be itself edible and in some cases suitable for being incorporated into food products, for example, acidic food products. In certain embodiments the sensitive substances are sensitive to acidity, oxygen or other agents or conditions. In certain embodiments the delivery systems provide a mixture of hydrophobic sensitive substances and/or hydrophilic sensitive substances.

In accordance with one aspect, complex coacervates are provided, that are suitable for consumption as an ingredient in a food product and, in at least certain embodiments, “as is,” i.e., without other ingredients. A complex coacervate in accordance with this disclosure can be formed by combining a sensitive substance wax-in-water emulsion with one or more cationic polymers. The sensitive substance wax-in-water emulsion can be prepared by combining a sensitive substance as described above with a wax solution to form a sensitive substance wax solution. The “wax solution” may be wax alone or with other ingredients, for example, melted wax (also referred to here as a melted wax solution), liquid wax, a liquid mixture or slurry of wax with one or more other ingredients, e.g., diluents, solvents, etc. The “sensitive substance” may be one or more sensitive substances alone or with other ingredients, e.g., a mixture of multiple sensitive substances alone or with one or more other ingredients, e.g., diluents, solvents, etc. The sensitive substance is combined with the wax solution. For example, the sensitive substance can be added into the wax solution or they can be otherwise combined. As used in this disclosure, unless otherwise specified, the term “added” or “combined” and like terms means that the multiple ingredients or components (e.g., one or more sensitive substances and a melted wax solution) are combined in any manner and in any order, with or without stirring or the like, with or without heating, etc. For example, one or more ingredients can be dissolved into one or more other ingredients, or sprayed together, etc. Combining the sensitive substance and wax solution forms a sensitive substance wax solution, alternatively referred to here as a wax mixture or a sensitive substance-in-wax solution, which may be a true solution, slurry, suspension, mixture or other form of liquid or flowable material. In certain embodiments, for example, fish oil is mixed with melted natural wax to form a homogenous solution. As used here, the term “homogenous” means commercially adequately homogenous for the intended use, e.g., as a stand-alone consumable or as an ingredient in a beverage or other food product.

The sensitive substance wax solution is combined with at least one anionic polymer emulsifier to form an emulsion, specifically, the sensitive substance wax-in-water emulsion referred to above, in some cases referred to here as a sensitive substance wax-in-water emulsion. In at least certain embodiments the emulsion is a nano solid lipid particle emulsion. Some exemplary (i.e., non-limiting) examples or embodiments of such emulsions are oil-in-water emulsions. Some exemplary embodiments of the emulsions disclosed here can be prepared by mixing melted wax with at least one sensitive substance, e.g., fish oil, to form a sensitive substance wax solution and then combining the sensitive substance wax solution with at least one anionic polymer, e.g., pectin, to form a sensitive substance wax-in-water emulsion.

Cationic polymer is combined with the sensitive substance wax-in-water emulsion, typically with mixing for a suitable period of time, e.g., from 1 to 5 minutes, to form complex coacervates. In at least certain embodiments, the complex coacervates are provided as an aqueous dispersion. In at least certain embodiments, the aqueous dispersion of complex coacervates is homogenized. For example, the aqueous dispersion can be agitated at room temperature for a period of time, e.g., from 15 minutes to an hour, e.g., for 30 min., followed by homogenizing at high pressure, e.g., at 3000 psi to 4000 psi.

By encapsulating the sensitive substance(s) in such complex coacervates, certain negative effects, e.g., oxidation, off flavor and/or unpleasant aroma, can be reduced or eliminated for at least a period of time, for example, during shipping and storage. Optionally, other ingredients may be included with the complex coacervates in an aqueous dispersion, e.g., a preservative, such as sodium benzoate. In at least certain embodiments the pH of the aqueous dispersion is adjusted, for example by the addition of acid, e.g., citric acid and/or other edible acids. The pH can be adjusted to a level suitable for the intended application, typically, for example, to a value of from pH 2.5 to pH 5.5, e.g., from pH 3.5 to pH 4.5.

In at least certain embodiments, an emulsion is provided having a core-shell capsule structure, wherein the core comprises sensitive substance and the shell comprises wax within a complex coacervate formed at least in part by cationic polymer and anionic polymer, whereby fish oil or other sensitive material is microencapsulated and protected. In at least certain embodiments, a nano solid lipid particle emulsion is provided, wherein the wax component is solid at room temperature. For example, stable and odourless emulsions of fish oil that are highly dispersible in an acidic beverage can be prepared according to certain exemplary embodiments of this disclosure, by dissolving the fish oil into melted natural wax to form a homogenous solution that is added into a solution of pectin and/or other emulsifier anionic polymer under high mixing to form a nano solid lipid particle emulsion; the emulsion capsules are further protected by adding whey protein and/or other cationic polymer with mixing for 2-4 minutes (e.g., for 3 minutes) to form complex coacervates; sodium benzoate and/or other preservative is added; citric acid and/or other edible acid is added to adjust the pH to a value of pH 3 to pH 5 (e.g., pH 4); and the emulsion is agitated at room temperature for 20 to 40 minutes (e.g., for 30 minutes) and then homogenised at 3000 psi to 4000 psi. Exemplary beverages containing such exemplary fish oil emulsions, having a pH value of pH 2.5 to pH 3.5 (e.g., pH 2.9) and providing 50.0 mg EPA/DHA per 15.0 oz. to 25.0 oz. (e.g., per 19.6 oz.) can be prepared and in at least some embodiments have no detectable fish taste or odor after storage at elevated temperature, e.g., at 90° F. for 3 weeks.

In another aspect, food products are provided comprising complex coacervates as disclosed above, e.g., comprising an aqueous dispersion of the complex coacervates, together with one or more other edible ingredients. In some exemplary embodiments the food product comprises the complex coacervates together with one or more nutritional ingredients, e.g., grain component(s), protein, fruit juice or other juice component(s), vegetable juice and/or vegetable component(s), minerals, vitamins, combinations of any of them, etc. As used here, a food product comprises an aqueous dispersion of complex coacervates where the food product comprises one or more such aqueous dispersions. The food product comprises such aqueous dispersion notwithstanding that some or all of the water or other diluent or solvent, and/or other expendable ingredient(s) of the aqueous dispersion have been removed from the final food product after addition of the aqueous dispersion. For example, some or all of the water of the aqueous dispersion may be removed prior to, during or after mixing with other ingredients of the food product. In certain exemplary embodiments, the food products are beverages, e.g., fruit juice beverages, carbonated soft drinks etc., wherein the aqueous dispersion is from 0.05 to 3.0 weight percent (wt. %) of the finished beverage, e.g., from 0.1 to 2.0 wt. %.

These and other aspects, advantages and features of the present invention herein disclosed will become apparent through reference to the following detailed description. Furthermore, it is to be understood that the features of the various embodiments described herein are not mutually exclusive and exist in various combinations and permutations in other embodiments.

### DETAILED DESCRIPTION OF CERTAIN EMBODIMENTS

Various examples and embodiments of the inventive subject matter disclosed here are possible and will be apparent to the person of ordinary skill in the art, given the benefit of this disclosure. In this disclosure reference to “some embodiments,” “certain exemplary embodiments” and similar phrases means that those embodiments are merely non-limiting examples of the inventive subject matter and that there likely are other, alternative embodiments which are not excluded. Unless otherwise indicated or unless otherwise clear from the context in which it is described, alternative elements or features in the embodiments and examples below and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the devices and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited.

As disclosed above, aspects of the invention relate to complex coacervates (also referred to here as wax complex coacervates) for delivering, storing and/or protecting sensitive substances. For example, complex coacervates disclosed here can provide a stable composition suitable for inclusion in food products. That is, at least certain embodiments of the complex coacervates disclosed here are stable for shelf-storage and/or for use in making food products, e.g., for shelf-storage when included in acidic food products. At least certain embodiments of the complex coacervates disclosed here can reduce or eliminate an unpleasant taste or odor of a sensitive substance, such as, e.g., of fish oil, and/or can reduce degradation, e.g., by oxidation or hydrolysis of sensitive substances. Certain embodiments of the complex coacervates disclosed here can be incorporated into a food product associated with health benefits, for example orange juice, to provide enhanced nutritional value. Additionally, certain of the complex coacervates are suitable to be incorporated into food products such as acidic soft drinks, e.g., carbonated soft drinks. By encapsulating such sensitive substances in wax complex coacervates as disclosed here, negative visual and physical changes to the food product may be reduced or avoided for a more appealing food product.

In certain exemplary embodiments, wax complex coacervates as disclosed above are provided in an aqueous dispersion. As used here, an aqueous dispersion comprises, consists essentially of, or consists of particles distributed throughout a medium of liquid water, e.g., as a suspension, a colloid, an emulsion, a sol, etc. The medium of liquid water may be pure water or may be a mixture of water with at least one water-miscible solvent or diluent, such as, for example, ethanol or other alcohols, propylene glycol, glycerin, etc. In some exemplary embodiments there may be a substantial concentration of water-miscible solvent in the aqueous dispersion of the wax complex coacervates, such as, between about 1% and about 20% by volume, for example from 5% to 15% by volume, e.g., from 10% to 15%. In other exemplary embodiments, the wax complex coacervates are diluted into a food product and the amount or concentration of water-miscible solvent is negligible.

As used here, a “complex coacervate” or “wax complex coacervate” is a clearly identifiable discrete particle containing one or more sensitive substances, e.g. fish oil and/or other oil, water-insoluble vitamins, water-insoluble vitamins, flavors, etc., enveloped by a shell comprising at least two oppositely charged polymers, that is, cationic polymer of at least one type and anionic polymer of at least one type, that envelopes or separates the sensitive substance from the environment surrounding the particle. Such polymers include not only traditional polymers, but also oligomers and the like. In certain exemplary embodiments the complex coacervates are substantially non-agglomerated, but comprise a single shell encapsulating a single core. In other embodiments some or all of the complex coacervates are agglomerated. Such agglomerations of complex coacervates may be referred to as aggregates of complex coacervates or simply as aggregates. Such aggregates in some exemplary embodiments include other material(s), e.g., other emulsified materials, etc.

In some embodiments of the food products disclosed here, essentially all of the sensitive substance is incorporated into the wax complex coacervates. As used here, “essentially all of the sensitive substance” means that the concentration or amount of the sensitive substance not incorporated into the wax complex coacervates is less or lower than the taste or smell threshold for most people in the food product in question. In some other embodiments the aqueous dispersion includes a perceptible concentration of the sensitive substance in addition to the portion incorporated into the wax complex coacervates and/or wax emulsion.

In certain exemplary embodiments the “sensitive substance” comprises, consists essentially of, or consists of a water immiscible material, e.g., fish oil or other nutritional oil, a lipid, a water-insoluble vitamin (e.g., α-tocopherol or other tocopherol), a water-insoluble sterol, a water-insoluble flavonoid, a flavor, an essential oil or a combination of any of them. It should be understood that the term “fish oil,” unless stated otherwise, is broad enough to include fish oil comprising other ingredients, e.g., preservatives, diluents, solvents, etc. In other embodiments the “sensitive substance” comprises, consists essentially of, or consists of a water miscible material, e.g., a water-soluble vitamin, a water-soluble sterol, a water-soluble flavonoid, mineral, extracts from plants, herbs, DNA, amino acid, water soluble organic compounds or a combination of any of them. The sensitive substance may be a solid, a liquid or a mixture of both in the emulsions and complex coacervates disclosed here. In some embodiments the sensitive substance is a combination of water immiscible material and water soluble material. As used here the term “lipid” encompasses any substance that contains one or more fatty acid residues, including free fatty acids. Thus, the term “lipid” encompasses, for instance, triglycerides, diglycerides, monoglycerides, free fatty acids, phospholipids or a combination of any of them. As used here the term “fatty acid” encompasses free fatty acids as well as fatty acid residues. Whenever reference is made herein to a weight percentage of fatty acids, this weight percentage includes free fatty acids as well as fatty acid residues (e.g. fatty acid residues contained in triglycerides). Further, as used herein a “polyunsaturated fatty acid” (PUFA) encompasses any fatty acid containing 2 or more double bonds in the carbon chain.

At least some exemplary embodiments of the complex coacervates disclosed here can be characterized as having a core-shell capsule structure. A core-shell structure is believed to be produced in such embodiments by combining the wax solution with the core substance, i.e., the sensitive substance to be protected. For example, solid wax to be mixed with the sensitive substance can be heated to or beyond its melting temperature, typically to a temperature within the range of 30° C. to 150° C., e.g., within the range of 70° C. to 80° C., for at least a period of time long enough to melt or pre-melt the wax. Mixing and/or heating optionally can be continued during forming of the homogeneous wax solution or wax mixture with the sensitive substance. The duration of mixing and/or heating, if any, in producing the wax mixture will in at least some embodiments depend in part on the solubility of the sensitive substance in the wax. In certain embodiments the resulting wax mixture is an aqueous solution comprising from 0.05 wt. % to 5.0 wt. % wax, e.g., from 0.5 wt. % to 2.0 wt. % wax.

In exemplary embodiments the wax is a natural wax, for example, bees wax and/or plant wax (i.e., a wax derived from plant material). In certain embodiments the natural wax is selected from the group including, for example, candelilla wax, carnauba wax, palm oil, shellac, fatty acid, fatty acid salts, fatty acid ester, fatty alcohol, fatty triglyceride, lecithin, and combinations of any of them. In certain exemplary embodiments, the natural wax comprises candelilla wax or carnauba wax. In certain exemplary embodiments the wax is a synthetic wax, e.g., a paraffin wax. In some exemplary embodiments the wax and/or resulting wax mixture is solid at room temperature, e.g., at any or alternatively at all temperatures within the range of 20° C. to 25° C.

In certain embodiments an antioxidant is added to the wax with or prior to the addition of sensitive substance(s), e.g., antioxidant selected from butylated hydroxytoluene, butylated hydroxyanisole, tert-butyhydroquinone, quercetin, tocopherol, vitamin C, water soluble polyphenols, water soluble plant extracts (e.g., extracts from herbs, other botanicals or other plants) and combinations of any of them. In certain exemplary embodiments the antioxidant is vitamin C.

In certain embodiments the sensitive substance-in-wax solution comprising melted wax and sensitive substance, e.g., fish oil, as described above, is cooled to room temperature (e.g., 68° F.-75° F., e.g., 70° F., or 20° C.-24° C.). It is currently understood that as the temperature of the wax cools to room temperature the sensitive substance is encapsulated or microencapsulated with the wax, thereby forming wax balls containing the sensitive substance. In at least certain embodiments such “wax balls” form the core of the complex coacervates. It is understood that the wax forms a layer that separates the sensitive substance(s) from the environment surrounding the wax ball.

In certain embodiments the sensitive ingredient may be selected from the group including, for example, omega-3 fatty acids, flavor oils, and lipophilic nutrients and combinations of any of them. In certain exemplary embodiments the sensitive ingredient is fish oil. In certain embodiments of the sensitive substance wax-in-water emulsions described here, e.g., emulsions formed by dissolving fish oil into melted natural wax, the at least one sensitive substance is present in an amount of 0.1 wt. % to 40 wt. %, e.g., from 1.0 wt. % to 10 wt. % of the sensitive substance wax-in-water emulsion. In certain embodiments of the aqueous dispersions of complex coacervates described here, e.g., dispersions formed by adding cationic polymer to a sensitive substance wax-in-water emulsion followed by homogenizing, as described above, e.g., those formed of emulsion made with fish oil in melted natural wax, the at least one sensitive substance is present in an amount of 0.1 wt. % to 40.0 wt. %, e.g., from 1.0 wt. % to 10.0 wt. % of the aqueous dispersion of complex coacervates.

In certain exemplary embodiments where the the sensitive ingredient comprises one or more lipophilic nutrients, it may, e.g., include fat soluble vitamins, (e.g., vitamins A, D, E, and K), tocotrienols, carotenoids, xanthophylls, (e.g., lycopene, lutein, astaxanthin, and zeazanthin), fat-soluble nutraceuticals including phytosterols, stanols and esters thereof, Coenzyme Q10 and ubiquinol, hydrophobic amino acids and peptides, essential oils and extracts, and fatty acids. Fatty acids may include, for example, conjugated linolenic acid (CLA), omega-6 fatty acids, and omega-3 fatty acids. Suitable omega-3 fatty acids include, e.g., short-chain omega-3 fatty acids such as alpha-linolenic acid (ALA), which are derived from plant sources, for example flaxseed, and long-chain omega-3 fatty acids such as eicosapentaenoic acid (EPA), steradonic acid and docosahexaenoic acid (DHA). The long-chain omega-3 fatty acids can be derived from, for example, marine or fish oils. Such oils can be extracted from various types of fish or marine animals, such as anchovies, capelin, cod, herring, mackerel, menhaden, salmon, sardines, shark and tuna, or from marine vegetation, such as micro-algae, or a combination of any of them. Other sources of omega-3 fatty acids include liver and brain tissue and eggs.

In certain exemplary embodiments where the the sensitive ingredient comprises one or more water-insoluble flavorants, they may include, for example, any substance that provides a desired flavor to a food or beverage product, which does not substantially dissolve in water (e.g., non-polar, hydrophobic substances such as lipids, fats, oils, etc.). The flavorant may be a liquid, gel, colloid, or particulate solid, e.g., an oil, an extract, an oleoresin, or the like. Exemplary water-insoluble flavorants include, but are not limited to, citrus oils and extracts, e.g. orange oil, lemon oil, grapefruit oil, lime oil, citral and limonene, nut oils and extracts, e.g. almond oil, hazelnut oil and peanut oil, other fruit oils and extracts, e.g. cherry oil, apple oil and strawberry oil, botanical oils and extracts, e.g., coffee oil, mint oil, vanilla oil, and combinations of any of them.

As disclosed above, an anionic polymer (meaning, as used here, at least one anionic polymer and optionally a mixture of anionic polymers) is combined with a sensitive substance-in-wax solution to form the sensitive substance wax-in-water emulsion, also referred to here as a wax oil-in-water emulsion. In at least certain exemplary embodiments, homogenizing is used in forming the wax oil-in-water emulsion. The anionic polymer comprises, for example, gum arabic, modified starches, pectin, Q-200 (available from National Starch), carrageenan, alginate, xanthan gum, modified celluloses, carboxymethylcellulose or carboxyl methyl cellulose (CMC), gum acacia, gum ghatti, gum karaya, gum tragacanth, locust bean gum, guar gum, psyllium seed gum, quince seed gum, larch gum (arabinogalactans), stractan gum, agar, furcellaran, gellan gum, or a combination of any of them. In some exemplary embodiments the anionic polymer is gum arabic. In certain exemplary embodiments, the oil-in-wax solution is added to the emulsifier solution under high-shear mixing conditions to make an oil-in-water emulsion, followed by homogenizing (e.g., at 3000 psi to 4000 psi) to achieve small particle size. In certain embodiments the anionic polymer is present in an amount of 5.0 wt. % to 40.0 wt. % of the final coacervate emulsion, e.g., from 10.0 wt. % to 15.0 wt. %.

As disclosed above, cationic polymer (meaning, as used here, at least one cationic polymer and optionally a mixture of cationic polymers) is combined with the sensitive substance-in-wax emulsion. Optionally, in some embodiments an antioxidant and/or a stabilizer is also included. In certain exemplary embodiments, the at least one cationic polymer is added to the sensitive substance-in-wax emulsion under high-shear mixing conditions followed by homogenization under 4000-4500 psi to form coacervate complex. In certain embodiments the at least one cationic polymer is present in an amount up to 20.0 wt. % of the aqueous dispersion of complex coacervates, e.g., from 1.0 wt. % to 15.0 wt. %. The cationic polymer may comprise, consist essentially of or consist of, for example, proteins, such as dairy proteins, including whey proteins, caseins and fractions thereof, gelatin, vegetable and other plant proteins, e.g., corn zein protein, grain protein extracts, e.g. protein from wheat, barley, rye, oats, etc., legume proteins and other vegetable proteins, proteins from tree nuts, proteins from ground nuts, bovine serum albumin, egg albumin, microbial proteins, chitosan, and the like, and combinations of any of them. It is recognized that the above categories of cationic polymers are in part overlapping or redundant. In an exemplary embodiment the cationic polymer is whey protein. In certain embodiments whey protein may be used, selected for example from beta-lactoglobulin (BLG), whey protein isolate (WPI), whey protein concentrate, peptides, amino acids, soy proteins or a combination of any of them. In some exemplary embodiments the whey protein is BLG and pectin is used as the anionic polymer for forming the sensitive substance wax-in-water emulsion.

In certain embodiments the complex coacervates have a negative zeta potential, that is, the outside of the complex coacervate shell displays a net negative charge. In certain exemplary embodiments the shell includes a net positive charged (cationic) polymer and a net negative charged (anionic) polymer. It is currently believed that the net charge of each polymer is dependent on the pH of the environment and the isoelectric point of each polymer, which is in turn dependent on the density of ionizable groups in each polymer and the pKa values of those groups. Thus, disclosure here of complex coacervates comprising anionic and cationic polymers refers to the charge of the polymers in the environment or reaction conditions used for formation of the complex coacervates. Complex coacervates of the type used here are presently understood to be stabilized at least in part by the electrostatic attraction between the oppositely charged polymers.

In certain embodiments a stabilizer is added to the sensitive substance-in-wax solution before the at least one cationic polymer is added. The stabilizer may be selected from sucrose ester, triglycerides, lecithin, ester gum, and combinations of any of them. In an exemplary embodiment the stabilizer is sucrose ester containing triglycerides or ester gum.

In certain exemplary embodiments, the complex coacervates comprise, for example, 0.05 wt. %-5.0 wt. % wax, e.g., from 0.5 wt. %-5.0 wt. % wax ; 0.1 wt. %-40.0 wt. % sensitive substance (meaning here and in other similar usages, the combined total weight percent of the one or more sensitive substances included in the complex coacervates), e.g., from 10.0 wt. % to 15.0 wt. % sensitive substance(s); 5.0 wt. % to 40.0 wt. % anionic polymer, e.g., from 10.0 wt. % to 15.0 wt. %; and up to 20.0 wt. % cationic polymer, e.g., from 5.0 wt. % to 15 wt. % cationic polymer. In some embodiments, the complex coacervates comprise, for example, 0.05 wt. % to 5.0 wt. % wax; 0.1 wt. % to 40.0 wt. % of the at least one sensitive substance; 1.0 wt. % to 3.0 wt. % of antioxidant; 5.0 wt. % to 40.0 wt. % of the at least one of the anionic polymer; 0.5 wt. % to 5.0 wt. % of the at least one of the cationic polymer; and 0.1 wt. % to 5.0 wt. % of stabilizer. In certain exemplary embodiments, the coacervate complexes contain, for example, at least 1.0 wt. %, e.g., up to 10.0 wt. %, of one or more polyunsaturated fatty acids selected from omega-3 fatty acids, omega-6 fatty acids and combinations of any of them. In certain embodiments, the one or more polyunsaturated fatty acids are selected from DHA, EPA, CLA, and combinations of any of them.

In certain exemplary embodiments, at least a majority of the complex coacervates of the present invention have a volume weighted average diameter in the range of, for example, 0.1 μm to 20.0 μm, e.g., a diameter in the range of 0.3 μm to 1.5 μm. As used here, the “diameter” is the largest dimension of the particle, and the particle need not be spherical.

In certain exemplary embodiments, the aqueous dispersion of the present invention may contain other dispersed components in addition to the complex coacervates. In certain embodiments, the dispersion contains less than 20 wt. % of one or more dispersed edible components, including the dispersed complex coacervates. In certain exemplary embodiments some or all of the complex coacervates (alone or as an aqueous dispersion and/or as included in a food product) are substantially stabilized, for example by substantial gelling or substantial hardening of the complex coacervates, aggregation, etc. In other embodiments the complex coacervates or aqueous dispersion are not substantially stabilized.

In certain exemplary embodiments, the aqueous dispersion of complex coacervates is maintained as an aqueous dispersion. In alternative embodiments, the aqueous dispersion of complex coacervates is, for example, spray dried, freeze dried, drum dried, or bed dried. If maintained as an aqueous dispersion, in certain embodiments, the aqueous dispersion of complex coacervates is treated to inhibit microbiological growth. In certain embodiments, the aqueous dispersion of complex coacervates is, for example, pasteurized, aseptically packaged, treated with chemical preservatives, e.g., sodium benzoate, potassium sorbate, lauric alginate, polylysine, natamycin, velvorin, etc., and/or treated with acid, e.g., citric acid, phosphoric acid, etc. In some exemplary embodiments, the aqueous dispersion of complex coacervates has minimized contact with air during production, is pasteurized after production, and is stored in a refrigerator with limited exposure to light, e.g., sunlight and/or artificial light.

In certain exemplary embodiments, a desired amount of sensitive substance, e.g. fish oil or other hydrophobic substance in the form of the above-described complex coacervates is included in a food product in the form of complex coacervates as disclosed here. The amount of complex coacervates, and hence the amount of hydrophobic substance included in the food product may vary depending on the application and desired taste characteristics and nutrition of the food product. The complex coacervates may be added to the food product in any number of ways, as would be appreciated by those of ordinary skill in the art given the benefit of this disclosure. In certain exemplary embodiments, the complex coacervates are sufficiently mixed in the food product to provide a substantially uniform distribution, for example a stable dispersion. Mixing should be accomplished such that the complex coacervates are not destroyed, i.e., the encapsulation of the wax-protected sensitive substance is left largely intact. If the complex coacervates are destroyed, oxidation of the hydrophobic substance may result. Suitable mixer(s) can be selected for a specific application based, at least in part, on the type and amount of ingredients used, the viscosity of the ingredients used, the amount of product to be produced, the flow rate, and the sensitivity of ingredients, such as the complex coacervates, to shear forces or shear stress.

Encapsulation of sensitive substance, e.g. fish oil or other hydrophobic substances using complex coacervates as disclosed here can in at least certain embodiments stabilizes the substance by protecting it from degradation by, for example, oxidation and hydrolysis. When included in an acidic food product, the complex coacervates can provide a stable dispersion of hydrophobic substances over the shelf life of the food product. Factors that may affect the shelf-life of a food product comprising complex coacervates disclosed here typically include, e.g., the level of processing the product undergoes, the type of packaging, and the materials used for packaging the product. Additional factors that may affect the shelf life of the product include, for example, the nature of the base formula (e.g., an acidic beverage sweetened with sugar has a longer shelf-life than an acidic beverage sweetened with aspartame) and environmental conditions (e.g., exposure to high temperatures and sunlight is deleterious to ready-to-drink beverages).

In certain exemplary embodiments of the food products disclosed here comprising complex coacervates, the food product is a beverage product. In certain embodiments, the beverage products are ready-to-drink beverages, beverage concentrates, syrups, shelf-stable beverages, carbonated soft drinks, refrigerated beverages, frozen beverages, or the like. In some exemplary embodiments the beverage product is acidic, e.g. having a pH within the range below about pH 5.0, e.g., a pH value within the range of about pH 1.0 to about pH 4.5, or in certain exemplary embodiments a pH value within the range of about pH 1.5 to about pH 3.8. In an exemplary embodiment the beverage product has a pH of 3.0. Beverage products comprising complex coacervates disclosed here include, but are not limited to, e.g., colas, lemon-lime and other carbonated and non-carbonated soft drinks, fountain beverages, liquid concentrates, fruit juice and fruit juice-flavored drinks, sports drinks, energy drinks, fortified/enhanced water drinks such as so called near waters, soy drinks, vegetable drinks, grain-based drinks (e.g. malt beverages), fermented drinks (e.g., yogurt drinks, smoothies, kefir drinks and the like), coffee beverages, tea beverages, dairy beverages, and mixtures thereof. Exemplary fruit juice sources include citrus fruit, e.g. orange, grapefruit, lemon and lime, berry, e.g. cranberry, raspberry, blueberry and strawberry, apple, grape, pineapple, prune, pear, peach, cherry, mango, and pomegranate. Beverage products include bottle, can, and carton products and fountain syrup applications.

Certain embodiments of other food products comprising complex coacervates disclosed here include fermented food products, yogurt, sour cream, cheese, salsa, ranch dip, fruit sauces, fruit jellies, fruit jams, fruit preserves, and the like. In certain exemplary embodiments, the food product is acidic, e.g. having a pH value within the range below about pH 5.0, in certain exemplary embodiments, a pH value within the range of about pH 1.0 to about pH 4.5, or in certain exemplary embodiments, a pH value within the range of about pH 1.5 to about pH 3.8. In an exemplary embodiment the food product has a pH of 3.0.

The food products disclosed here may optionally include other additional ingredients. In certain embodiments, such additional ingredients may include, for example, vitamins, minerals, sweeteners, water-soluble flavorants, colorings, thickeners, emulsifiers, acidulants, electrolytes, antifoaming agents, proteins, carbohydrates, preservatives, water-miscible flavorants, edible particulates, and mixtures thereof In certain embodiments, other ingredients are also contemplated. In at least some exemplary embodiments, the ingredients can be added at various points during processing, including before or after pasteurization, and before or after addition of the complex coacervates.

In at least certain exemplary embodiments, food products disclosed here may be pasteurized. The pasteurization process may include, for example, ultra high temperature (UHT) treatment and/or high temperature-short time (HTST) treatment. The UHT treatment includes subjecting the food or beverage product to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the food or beverage product is subjected to heating to about 185° F. (85° C.) to about 250° F. (121° C.) for a short period of time, for example, about 1 to 60 seconds, then cooled quickly to about 36° F. (2.2° C.)+/10° F. (5° C.) for refrigerated products, to ambient temperature for shelf stable or refrigerated products, and to about 185° F. (85° C.)+/−10° F. (5° C.) for hot-fill applications for shelf-stable products. The pasteurization process is typically conducted in a closed system, so as not to expose the food product to atmosphere or other possible sources of contamination. In alternative embodiments, other pasteurization or sterilization techniques may also be useful, such as, for example, aseptic or retort processing. In addition, multiple pasteurization processes may be carried out in series or parallel, as necessitated by the food product or ingredients.

Some food products in accordance with this disclosure optionally may, in addition, be post processed. In exemplary embodiments, post processing is typically carried out following addition of the complex coacervates. Post processing can include, for example, cooling the product solution and filling it into a container for packaging and shipping. In certain embodiments, post processing may also include deaeration of the food product to less than 4.0 ppm oxygen, preferably less than 2.0 ppm and more preferably less than 1.0 ppm oxygen. In alternative embodiments deaeration and other post processing tasks may be carried out prior to processing, prior to pasteurization, prior to mixing with the complex coacervates and/or at the same time as adding the complex coacervates. In addition, in certain embodiments, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

### EXAMPLES

The following are examples of specific embodiments of the present invention, but are not intended to limit it.

### Example 1

In a 50 ml round flask with a stirring bar, 0.8 g carnauba wax melted at 86° C. and then 9.4 g (40% EPA/DHA) omega-3 oil was added and mixed until an homogeneous wax solution (“Omega-3 wax solution”) was obtained. The Omega-3 wax solution was added under high shear mixing to 230 g gum arabic solution (20%) containing 6 g ascorbic acid to form a wax oil-in-water emulsion. Subsequently, 60 g solution of β-Lactoglobulin (15%) was added slowly to form a coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00. The coacervate emulsion was added to the beverage and dispersed in the beverage. Additional ingredients were added in the concentrations (w/w) listed below to make an isotonic beverage containing omega-3. The pH was about 3.0. The pH range of the resultant isotonic beverage may be about 2.5-4.5.

TABLE 1
High-Acid Omega-3 Beverage

| | Amount |
|---|---|
| Ingredient | (% by wt.) |
| Water | 95.23% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Wax Emulsion | 0.5-1.5% |
| Reb A | 0.015% |
| Vitamin C (Ascorbic Acid) | 0.105% |
| Erythritol | 0.90% |
| Total | 100.000% |

### Example 2

In a 50 ml round flask with a stirring bar, 2.0 g candelilla wax melted at 75° C. and then 15 g (22% EPA/DHA) fish oil and 8 g sucrose ester (SAIB-MCT) were added and mixed until an homogeneous wax solution (“Omega-3 wax solution”) was obtained. To 225 g gum arabic solution (20%) containing 0.5 g ascorbic acid the Omega-3 wax solution was added under high shear mixing to form a wax oil-in-water emulsion. The emulsion was further mixed for 2 minutes at room temperature and then homogenized by 1-2 pass under 3000-4500 psi. Sodium benzoate (0.3 g) was added to the emulsion and pH adjusted 4.00.

### Example 3

In a 50 ml round flask with a stirring bar, 2.0 g candelilla wax melted at 75° C. and then 15 g (22% EPA/DHA) fish oil and 8 g sucrose ester (SAIB-MCT) were added and mixed until an homogeneous wax solution (“Omega-3 wax solution”) was obtained. To 225 g gum arabic solution (20%) containing 1.5 g ascorbic acid the Omega-3 wax solution was added under high shear mixing to form a wax oil-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00.

### Example 4

In a 50 ml round flask with a stirring bar, 3.2 g carnauba wax melted at 86° C. and then 16 g (22% EPA/DHA) fish oil was added and mixed until an homogeneous wax solution (“Omega-3 wax solution”) was obtained. To 225 g gum arabic solution (20%) containing 1.65 g ascorbic acid the Omega-3 wax solution was added under high shear mixing to form an oil-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00.

### Example 5

In a 50 ml round flask with a stirring bar, 9 g palm oil wax melted at 45° C. and then 15 g (22% EPA/DHA) fish oil was added and mixed until an homogeneous wax solution (“Omega-3 wax solution”) was obtained. To 225 g gum arabic solution (20%) the Omega-3 wax solution was added under high shear mixing to form a wax oil-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00.

### Example 6

In a 50 ml round flask with a stirring bar, 3.0 g candelilla wax melted at 75° C. and then 20 g citral was added and mixed until an homogeneous wax solution (“citral wax solution”) was obtained. To 225 g gum arabic solution (20%) the citral wax solution was added under high shear mixing to form an oil-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00.

### Example 7

In a 50 ml round flask with a stirring bar, 5.0 g candelilla wax melted at 75° C. and then 3.0 g ferrous lactate was added and mixed to form a ferrous lactate wax mixture. To 225 g gum arabic solution (20%) the ferrous lactate wax mixture was added under high shear mixing to form a wax-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.00.

### Example 8

In a 50 ml round flask with a stirring bar, 5.0 g candelilla wax melted at 75° C. and then 3.0 g magnesium oxide was added and mixed to form a magnesium oxide wax mixture. To 225 g gum arabic solution (20%) the magnesium oxide wax mixture was added under high shear mixing to form a wax-in-water emulsion. Subsequently, 60 g solution of β-Lactoglobulin (5%) was added slowly to form an aqueous dispersion of coacervate complex emulsion at pH 3-5. The coacervate emulsion was further mixed for 2 minutes at room temperature and then homogenized by 1-2 pass under 3000-4500 psi. Sodium benzoate (0.3 g) was added to the emulsion and pH adjusted 4.0.

Example Test Results. The following table shows the results of sensory tests performed on the samples prepared according to the forgoing examples, following storage at 70-75° F. for the time periods indicated.

TABLE 2
Omega-3 Stability in High-Acid Beverage

| Example | Stability (70-75° F.) |
|---|---|
| 1 | at least 2 months (no fish odor and taste) |
| 2 | at least 1 month (no fish odor and taste) |
| 3 | at least 2 months (no fish odor and taste) |
| 4 | at least 2 months (no fish odor and taste) |
| 5 | at least 1 month (no fish odor and taste) |

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An emulsion having a core-shell capsule structure, wherein the core comprises sensitive substance and the shell comprises a complex coacervate of wax, anionic polymer and cationic polymer.

2. The emulsion of claim 1 wherein the wax is selected from the group consisting of carnauba wax, candelilla wax, palm oil, shellac and fatty acid, fatty acid ester, fatty alcohol, fatty triglyceride, lecithin, paraffin and combinations of any of them.

3. The emulsion of claim 1 wherein the sensitive substance comprises a hydrophobic substance selected from lipids, water-insoluble vitamins, water-insoluble sterols, water-insoluble flavonoids, flavours, and essential oils and combinations of any of them.

4. The emulsion of claim 1 wherein the sensitive substance comprises a fatty acid selected from an omega-3 fatty acid, an omega-6 fatty acid, and combinations of any of them.

5. The emulsion of claim 1 wherein the sensitive substance is ascorbic acid, ferrous lactate, magnesium oxide, zinc oxide, calcium oxide, extracts from plants, herbs or botanicals, or a combination of any of them.

6. The emulsion of claim 1 wherein the anionic polymer is selected from gum arabic, pectin, xanthan gum, modified cellulose, carrageenan, gum acacia, ghatti gum, xanthan gum, gum karaya, gum tragacanth, locust bean gum, guar gum, psyllium seed gum, quince seed gum, larch gum (arabinogalactans), stractan gum, agar, furcellaran, gellan gum, modified starch, alginate, carboxyl methyl cellulose, and combinations of any of them.

7. The emulsion of claim 1 wherein the cationic polymer is selected from whey protein, beta-lactoglobulin (BLG), whey protein isolate (WPI) whey protein concentrate, peptides, amino acids, soy proteins, plant proteins, caseins and fractions thereof, other dairy proteins, gelatin, corn zein protein, bovine serum albumin, egg albumin, wheat protein extracts, barley protein extracts, rye protein extracts, oat protein extracts, other grain protein extracts vegetable proteins, microbial proteins, chitosan, legume proteins, tree nut proteins, ground nut protein, and combinations of any of them.

8. The emulsion of claim 1 further comprising antioxidant selected from butylated hydroxytoluene, butylated hydroxyanisole, tert-butyhydroquinone, quercetin, tocopherol, vitamin C, water soluble polyphenols, water soluble plant extracts, and combinations of any of them.

9. The emulsion of claim 1 further comprising a stabilizer selected from sucrose ester, triglycerides, lecithin, ester gum, fatty acids, fatty esters and combinations of any of them.

10. A food product comprising the emulsion of claim 1 and a second food ingredient.

11. A food product comprising an aqueous dispersion of the emulsion of claim 1 and a second food ingredient.

12. An aqueous dispersion of complex coacervates, prepared by:
a. providing a wax solution;
b. forming a sensitive substance wax solution, comprising combining a sensitive substance with the wax solution;
c. forming a sensitive substance wax-in-water emulsion, comprising combining the sensitive substance wax solution with at least one anionic polymer; and
d. forming an aqueous dispersion of complex coacervates, comprising combining at least one cationic polymer with the sensitive substance wax-in-water emulsion.

13. The aqueous dispersion of complex coacervates of claim 12 wherein the aqueous dispersion of complex coacervates is homogenized.

14. The aqueous dispersion of complex coacervates of claim 1 wherein a stabilizer is added to the sensitive substance-in-wax emulsion before combining with the cationic polymer.

15. The aqueous dispersion of complex coacervates of claim 1 wherein:
the wax solution consists essentially of melted wax, the anionic polymer comprises gum Arabic, the sensitive substance comprises fish oil, the cationic polymer comprises whey protein, and
antioxidant is added to one of the sensitive substance-in-wax solution and the anionic polymer before the anionic polymer and the sensitive substance-in-wax solution are combined.

16. The aqueous dispersion of complex coacervates of claim 15 wherein a stabilizer is added to the sensitive substance-in-wax emulsion before combining with the cationic polymer.

17. The aqueous dispersion of complex coacervates of claim 16 wherein the stabilizer is selected from sucrose ester, triglycerides, lecithin, ester gum, fatty acids, fatty esters and combinations of any of them

18. The aqueous dispersion of complex coacervates of claim 17 wherein the anionic polymer comprises gum arabic, the sensitive substance comprises omega-3 fatty acid, the cationic polymer comprises whey protein, the antioxidant comprises vitamin C, and the stabilizer comprises ester gum.

19. The aqueous dispersion of complex coacervates of claim 12 wherein the sensitive substance is combined with wax solution where the wax solution is at a temperature between 40° C. and 150° C.

20. The aqueous dispersion of complex coacervates of claim 12 wherein the anionic polymer is added to the sensitive substance-in-wax solution where both the anionic polymer and the sensitive substance-in-wax solution are at room temperature.

21. A food product comprising the aqueous dispersion of complex coacervates of claim 12 and a second food ingredient.

22. The food product of claim 21 wherein the food product is a beverage beverage having a pH value of pH 2.5 to pH 5.5.

23. A method for preparing an aqueous dispersion of complex coacervates comprising:
a. providing a wax solution;
b. forming a sensitive substance-in-wax solution, comprising combining the wax solution with at least one sensitive substance;
c. forming a sensitive substance-in-wax emulsion, comprising combining the sensitive substance-in-wax solution with at least one anionic polymer;
d. forming an aqueous dispersion, comprising dispersing the sensitive substance-in-wax emulsion in an aqueous medium; and
e. forming an aqueous dispersion of complex coacervates, comprising combining at least one cationic polymer with the sensitive substance-in-wax emulsion.

24. The method for preparing an aqueous dispersion of complex coacervates of claim 23 further comprising homogenizing aqueous dispersion of complex coacervates.

25. The method for preparing an aqueous dispersion of complex coacervates of claim 23 further comprising adding an antioxidant to the sensitive substance-in-wax solution before adding the at least one anionic polymer.

26. The method for preparing an aqueous dispersion of complex coacervates of claim 23 further comprising adding a stabilizer to the sensitive substance-in-wax emulsion before adding the at least one cationic polymer.
